(19) United States
(12) Patent Application Publication
(10) Pub. No.: US 2025/0022001 A1
(43) Pub. Date: Jan. 16, 2025

(54) METHODS AND SYSTEMS FOR PREDICTING REWARD LIABILITY DATA OF REWARD PROGRAMS

(71) Applicant: MASTERCARD INTERNATIONAL INCORPORATED, PURCHASE, NY (US)

(72) Inventors: Benjamin Matthew Jack, Tarrytown, NY (US); Ganesh Nagendra Prasad, Stamford, CT (US); FNU Karamjit Singh, Harrison, NY (US); Lekhana Vusse, Rajahmundry (IN); Gaurav Oberoi, Meerut (IN)

(21) Appl. No.: 18/771,593

(22) Filed: Jul. 12, 2024

(30) Foreign Application Priority Data
Jul. 14, 2023 (IN) 202341047684

(51) Int. Cl. G06Q 30/0202

(52) U.S. Cl. CPC G06Q 30/0202

(57) ABSTRACT

Methods and systems are provided for predicting reward liability data of reward programs. A method includes accessing, by a server system, historical reward related data associated with one or more reward programs administered by a reward program provider of reward program providers. The historical reward related data includes past redeemed reward points for each reward program aggregated on a particular time basis. Method includes identifying first seasonality patterns and second seasonality patterns associated with the historical reward related data. Method includes training a reward liability prediction model based on first and second seasonality patterns, wherein the trained time-series prediction model is configured to predict future reward liability data associated with the one or more reward programs. Upon training the model, the method includes modifying reward rules associated with the one or more reward programs based on predicted future reward liability data and one or more reward liability criteria.

### CROSS-REFERENCE TO RELATED APPLICATION

This application claims the benefit of, and priority to, Indian patent application Ser. No. 20/234,1047684 filed on Jul. 14, 2023. The entire disclosure of the above application is incorporated herein by reference.

### FIELD

The present disclosure relates to artificial intelligence technology and, more particularly to, electronic methods and complex processing systems for predicting reward liability for reward programs.

### BACKGROUND

This section provides background information related to the present disclosure which is not necessarily prior art.

Many companies run reward programs for specific assets or services to their consumers. For instance, a travel-based company, such as an airline or hotel chain, may offer an app enabling consumers to earn reward program points. For example, rewards are given to cardholders by merchants for various reasons, including encouraging certain consumer behaviors and also to strengthening relationships between issuers and cardholders. In one example, issuers also offer customer loyalty/incentive programs to cardholders who frequently make purchases using credit cards. The programs may give cardholders complimentary food and beverage, complimentary hotel stays, complimentary airline tickets, free services, free merchandise, reward points, discount coupons, and other benefits for cardholders. Such loyalty reward values are set by the businesses and constitute a promise for future consumption and therefore count as current liabilities on the balance sheet for the issuers. The issuers also manage funds to support the redemption of reward points in their reward programs (e.g., cost of gift cards, merchandise, or cashback).

Sometimes, the reward programs may increase funds liability for the issuers or reward program providers since these reward programs do not consider future funds liability data for the issuers for running these reward programs, resulting in more funds consumed for the issuers. Additionally, there are no tools available to manage a balance between the maximum loyalty effect and minimum rewards liability of the reward programs.

Reward liability prediction refers to the prediction of potential losses or risks associated with rewards programs. This may include the costs of rewards and the potential for fraud or abuse. The prediction of these liabilities is important for businesses to ensure the sustainability of their rewards programs and to minimize potential losses.

Thus, there exists a need for a technical solution for modelling and predicting reward liability data for issuers.

### SUMMARY

This section provides a general summary of the disclosure, and is not a comprehensive disclosure of its full scope or all of its features. Aspects and embodiments of the disclosure are set out in the accompanying claims.

Various embodiments of the present disclosure provide methods and systems for predicting reward liability for reward programs.

In an aspect, a computer-implemented method is disclosed. The method includes accessing, by a server system, historical reward related data associated with one or more reward programs administered by a reward program provider of a plurality of reward program providers. The historical reward related data includes past redeemed reward points for each reward program aggregated on a particular time basis. In addition, the method includes determining, by the server system, first seasonality patterns and second seasonality patterns associated with the historical reward related data based, at least in part, on a seasonality identification model. Moreover, the method includes training, by the server system, a reward liability prediction model based, at least in part, on first and second seasonality patterns, wherein the trained time-series prediction model is configured to predict reward liability data associated with the one or more reward programs.

Other aspects and example embodiments are provided in the drawings and the detailed description that follows. Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure. For a more complete understanding of example embodiments of the present technology, reference is now made to the following descriptions taken in connection with the accompanying drawings in which:

FIG. 1 is an exemplary representation of an environment related to at least some embodiments of the present disclosure;

FIG. 2 is a simplified block diagram of a server system, in accordance with an embodiment of the present disclosure;

FIG. 3 is a plot representing the effects of controlling reward point liability based on reward liability prediction model, in accordance with an embodiment of the present disclosure;

FIGS. 4A and 4B represent plots of seasonality detection within the historical reward related data of reward programs, in accordance with an embodiment of the present disclosure;

FIG. 5 is a process flow chart of a method for training a reward liability prediction model, in accordance with an embodiment of the present disclosure;

FIG. 6 is a process flow chart of a computer-implemented method for training a reward liability prediction model to determine future reward liability in a reward program, in accordance with an embodiment of the present disclosure;

FIG. 7A is a graphical representation comparing the prediction efficiency of baseline prediction model with the proposed reward liability prediction model;

FIG. 7B is a tabular representation of reward liability prediction of different reward programs; and

FIG. 8 is a simplified block diagram of an issuer server, in accordance with an embodiment of the present disclosure.

The drawings referred to in this description are not to be understood as being drawn to scale except if specifically noted, and such drawings are only exemplary in nature. Corresponding reference numerals indicate corresponding parts throughout the several views of the drawings.

### DETAILED DESCRIPTION

Example embodiments will now be described more fully with reference to the accompanying drawings. The description and specific examples included herein are intended for purposes of illustration only and are not intended to limit the scope of the present disclosure. In the following description, for purposes of explanation, numerous specific details are set forth in order to provide a thorough understanding of the present disclosure. It will be apparent, however, to one skilled in the art that the present disclosure can be practiced without these specific details.

Reference in this specification to “one embodiment” or “an embodiment”means that a particular feature, structure, or characteristic described in connection with the embodiment is included in at least one embodiment of the present disclosure. The appearance of the phrase “in an embodiment” in various places in the specification is not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon, the present disclosure.

Embodiments of the present disclosure may be embodied as an apparatus, system, method, or computer program product. Accordingly, embodiments of the present disclosure may take the form of an entirely hardware embodiment, an entirely software embodiment (including firmware, resident software, micro-code, etc.) or an embodiment combining software and hardware aspects that may all generally be referred to herein as a “circuit”, “engine”, “module”, or “system.” Furthermore, aspects of the present disclosure may take the form of a computer program product embodied in one or more computer readable storage media having computer-readable program code embodied thereon.

The term “payment account” used throughout the description refers to a financial account that is used to fund a financial transaction. Examples of the financial account include, but are not limited to a savings account, a credit account, a checking account, and a virtual payment account. The financial account may be associated with an entity such as an individual person, a family, a commercial entity, a company, a corporation, a governmental entity, a non-profit organization, and the like. In some scenarios, the financial account may be a virtual or temporary payment account that can be mapped or linked to a primary financial account, such as those accounts managed by payment wallet service providers, and the like.

The term “payment card”, used throughout the description, refers to a physical or virtual card linked with a financial or payment account that may be presented to a merchant or any such facility to fund a financial transaction via the associated payment account. Examples of the payment card include, but are not limited to, debit cards, credit cards, prepaid cards, virtual payment numbers, virtual card numbers, forex cards, charge cards, e-wallet cards, and stored-value cards. A payment card may be a physical card that may be presented to the merchant for funding the payment. Alternatively, or additionally, the payment card may be embodied in form of data stored in a user device, where the data is associated with a payment account such that the data can be used to process the financial transaction between the payment account and a merchant's financial account.

The term “payment network”, used herein, refers to a network or collection of systems used for the transfer of funds through the use of cash-substitutes. Payment networks may use a variety of different protocols and procedures to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, financial accounts, etc. Examples of networks or systems configured to perform as payment networks include those operated by such as, Mastercard®.

The terms “account holder”, “user”, “cardholder”, and “customer” are used interchangeably throughout the description and refer to a person who has a payment account or a payment card (e.g., credit card, debit card, etc.) associated with the payment account, that will be used by a merchant to perform a payment transaction. The payment account may be opened via an issuing bank or an issuer server.

### Overview

Various embodiments of the present disclosure provide methods and systems for predicting reward liability of reward programs to reward program providers. In other words, the present disclosure describes an automated approach for forecasting fund liability of reward points to be redeemed during the next month or year. The prediction of reward liabilities is done through data analysis and statistical modelling, taking into account factors such as past reward program data, customer behavior patterns, and market trends.

The present disclosure describes a server system that is configured to access historical reward related data associated with one or more reward programs administered by a reward program provider of a plurality of reward program providers. The historical reward related includes at least past redeemed reward points for each reward program aggregated on a particular time basis. The past redeemed reward points for each reward program are aggregated on the daily time basis.

In one embodiment, the server system is configured to determine first seasonality patterns and second seasonality patterns associated with the historical reward related data. In particular, the server system first detects seasonality trends within the historical reward related data of each reward program provider based, at least in part, on fast-Fourier transform (FFT). The first seasonality patterns includes yearly seasonal component of the past redeemed reward points and second seasonality patterns includes weekly seasonal component of the past redeemed reward points. Upon determination of the seasonality trends, the server system identifies the first seasonality patterns within the historical reward related data based, at least in part, on seasonality decomposition model and the second seasonality patterns within the historical reward related data based, at least in part, on seasonal lags in the moving average and auto-regressive components of a seasonal auto-regressive integrated moving average (SARIMA) time-series model.

In one embodiment, the server system is configured to train a reward liability prediction model based, at least in part, on first and second seasonality patterns, wherein the trained time-series prediction model is configured to predict reward liability data associated with the one or more reward programs. In one embodiment, the reward liability prediction model is implemented based at least on a seasonal auto-regressive integrated moving average (SARIMA) time-series model with exogenous and multiple seasonality. The reward liability prediction model is further trained based, at least in part, on exogenous variables. The exogenous variables include at least one seasonality pattern and a correlated variable. In one embodiment, the at least one seasonality pattern is determined based on a frequency level. The correlated variable includes aggregated earned reward points in each reward program for the reward program provider.

Once the reward liability prediction model is trained, the server system is configured to predict the future reward liability data associated with the one or more reward programs. Further, the server system is configured to modify reward rules associated with the one or more reward programs based, at least in part, the predicted future reward liability data and one or more reward liability criteria (e.g., reward liability budget thresholds).

Various embodiments of the present disclosure offer multiple technical advantages and technical effects. For instance, the present disclosure provides a server system configured to predict future reward point liability data of a reward program to reward program providers. The reward liability prediction model has advantages of both exogenous points earned information and multiple seasonality's. Further, the server system is configured to aggregate reward redemption data on daily basis that helps in improving prediction accuracy. Thus, the server system is also configured to use a combination of exogenous variables and multiple seasonality in SARIMA model during training. In a nutshell, the server system provides a scalable and powerful time-series model that generalizes intelligence over time-series data with multiple seasonality.

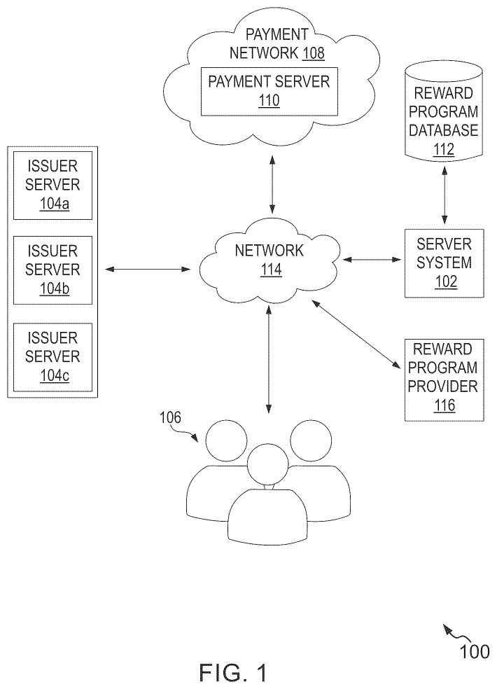

Various example embodiments of the present disclosure are described hereinafter with reference to FIGS. 1 to 8.

FIG. 1 is an exemplary representation of an environment 100 related to at least some embodiments of the present disclosure. Although the environment 100 is presented in one arrangement, other embodiments may include the parts of the environment 100 (or other parts) arranged otherwise depending on, for example, predicting reward liability data of a reward program for a reward program provider, etc. The environment 100 generally includes a plurality of entities, including a server system 102, a plurality of issuers 104a, 104b, and 104c, cardholders 106, a payment network 108 including a payment server 110, a reward program database 112, and a reward program provider 116, each coupled to, and in communication with (and/or with access to) a network 114. The network 114 may include, without limitation, a light fidelity (Li-Fi) network, a local area network (LAN), a wide area network (WAN), a metropolitan area network (MAN), a satellite network, the Internet, a fiber-optic network, a coaxial cable network, an infrared (IR) network, a radio frequency (RF) network, a virtual network, and/or another suitable public and/or private network capable of supporting communication among the entities illustrated in FIG. 1, or any combination thereof.

Various entities in the environment 100 may connect to the network 114 in accordance with various wired and wireless communication protocols, such as Transmission Control Protocol and Internet Protocol (TCP/IP), User Datagram Protocol (UDP), 2^{nd} Generation (2G), 3^{rd} Generation (3G), 4^{th} Generation (4G), 5^{th} Generation (5G) communication protocols, Long Term Evolution (LTE) communication protocols, future communication protocols or any combination thereof. For example, the network 114 may include multiple different networks, such as a private network made accessible by the payment network 108 to the issuer servers 104a-104c, the cardholders 106, separately, and a public network (e.g., the Internet, etc.).

The cardholders 106 may be an individual, representative of a corporate entity, non-profit organization, or any other person. In addition, each cardholder may have a payment account issued by corresponding issuing banks (associated with the issuer servers 104a-104c) and may be provided with a payment card with financial or other account information encoded onto the payment card such that each of the cardholders 106 may use the payment card to initiate and complete a payment transaction using a bank account at the issuing bank. Examples of the payment card may include, but are not limited to, a smartcard, a debit card, a credit card, and the like.

In one embodiment, the issuer server 104a is a financial institution that manages accounts of multiple account holders. In addition, account details of the payment accounts established with the issuer bank are stored in account holder profiles of the account holders (e.g., the plurality) in memory of the issuer server 104a or on a cloud server associated with the issuer server 104a. The terms “issuer server”, “issuer”, or “issuing bank” will be used interchangeably herein.

In one embodiment, the reward program provider 116 is a company or similar entity that hosts and/or manages a reward program (e.g., a frequent flyer miles program, a hotel-based rewards program, a supermarket or other store brand program, etc.). The reward program provider 116 includes at least one computing device, such as a server, that is configured to receive, store, process, and/or distribute data associated with the reward program. In some embodiments, the reward program provider 116 is an example of the payment server 116. The reward program provider 116 may manage reward programs for its associated issuers. In some examples, the reward program provider 116 is configured to manage the reward program and store reward data in a reward program database 112.

The reward program database 112 stores reward data that may include reward profile data for a plurality of cardholders of the reward program, account identifiers of accounts (e.g., bank accounts, credit accounts, other financial accounts, etc.) that are linked or otherwise associated with reward profiles of the plurality of cardholders, loyalty points accrued by loyalty profiles, point reward data (e.g., point amounts or rates of point rewards associated with purchases or other transactions, bonus point amounts or rates associated with defined merchants or categories of purchases, etc.), point redemption data (e.g., goods or services that can be purchased through point redemption, point values required for redemption, etc.), etc.

For instance, a cardholder may earn 1 reward point for each dollar spent using the cardholder account issued by issuer 104a. Further, cardholder may earn 5 loyalty points for each dollar spent in transactions with the reward program provider or an associated company. In this way, the cardholder may be incentivized to make purchases from the reward program provider in order to earn more reward points. The earned loyalty points may then be redeemed in exchange for products, services, funds deposited into the user's account, etc. Redemption rates for reward points may be defined such that redemption for goods or services provided by the reward program provider or an associated company provides a greater value than other methods of redemption, further incentivizing the cardholder to continue to do business with the reward program provider and/or associated companies.

In one non-limiting example, a cardholder wishes to perform a payment transaction using a payment card associated therewith to purchase goods or services offered by a merchant. After submitting a payment from the payment account associated with the payment card, a payment authorization request associated with the submitted payment is authorized in near real-time and the required funds associated with the payment are kept pending for the payment transaction. The funds are then debited from the payment account associated with the cardholder and credited to the payment account associated with the merchant. The funds are exchanged in place of goods or services provided by the merchant to the cardholder. The issuer server also determines whether the purchase qualifies for administrated reward programs. The reward programs may determine the identity of the product or service purchased, a purchase price of the product or service, the identity of the merchant, and the identity of the cardholder. For example, if the cardholder pays via a credit account associated with the credit card, a higher reward point value may be assigned to the purchase as compared to when the cardholder uses a debit account associated with the credit card or a debit card to pay. The reward point value is converted to a credit amount by the processor at the time of purchase. The credit amount is then automatically applied to the cardholder's account and stored in the reward program database associated with the issuer server without regard to a periodic time interval associated with the cardholder's account such as, for example, a multiple of the cardholder's billing cycle.

In general (not in accordance with embodiments of the present disclosure), sometimes, the issuers or the reward program providers do not have any visibility about fund consumption of their reward programs and fail to anticipate the rewards program liability. Thus, reward programs run by the reward program providers with an excessive reward will lead a bankruptcy of the reward program providers and alternatively, the reward programs being continuously adapted in order to prevent from the bankruptcy will thus make the consumers feel unconformable.

Therefore, there is a need of an effective and versatile reward liability prediction system which properly predicts future reward points redemption rates of the reward programs.

To overcome the above-mentioned issues, the server system 102 is configured to perform one or more of the operations described herein. The server system 102 is configured to predict future reward programs liabilities. The server system 102 is configured to accurately forecast future point's liability for reward programs to release or constrain incentives applied to cardholders in a reward program at program, segment or individual level.

The server system 102 is a separate part of the environment 100 and may operate apart from (but still in communication with, for example, via the network 112), the plurality of cardholders 104a-104c, the plurality of merchants 106a-106c, and any third-party external servers (to access data to perform the various operations described herein). However, in other embodiments, the server system 102 may actually be incorporated, in whole or in part, into one or more parts of the environment 100, for example, the cardholder 104a. In addition, the server system 102 should be understood to be embodied in at least one computing device in communication with the network 112, which may be specifically configured, via executable instructions, to perform as described herein, and/or embodied in at least one non-transitory computer-readable media.

In one embodiment, the server system 102 coupled with the reward program database 114 is embodied within the payment server 116, however, in other examples, the server system 102 can be a standalone component (acting as a hub) connected to the issuer server 108. The database 120 may be incorporated in the server system 102 or may be an individual entity connected to the server system 102 or may be a database stored in cloud storage.

In one embodiment, the payment network 114 may be used by the payment card issuing authorities as a payment interchange network. The payment network 114 may include a plurality of payment servers such as the payment server 116. Examples of payment interchange network include, but are not limited to, Mastercard® payment system interchange network. The Mastercard® payment system interchange network is a proprietary communications standard promulgated by Mastercard International Incorporated® for the exchange of financial transactions among a plurality of financial activities that are members of Mastercard International Incorporated®. (Mastercard is a registered trademark of Mastercard International Incorporated located in Purchase, N.Y.).

The number and arrangement of systems, devices, and/or networks shown in FIG. 1 are provided as an example. There may be additional systems, devices, and/or networks; fewer systems, devices, and/or networks; different systems, devices, and/or networks; and/or differently arranged systems, devices, and/or networks than those shown in FIG. 1. Furthermore, two or more systems or devices shown in FIG. 1 may be implemented within a single system or device, or a single system or device shown in FIG. 1 may be implemented as multiple, distributed systems or devices. Additionally, or alternatively, a set of systems (e.g., one or more systems) or a set of devices (e.g., one or more devices) of the environment 100 may perform one or more functions described as being performed by another set of systems or another set of devices of the environment 100.

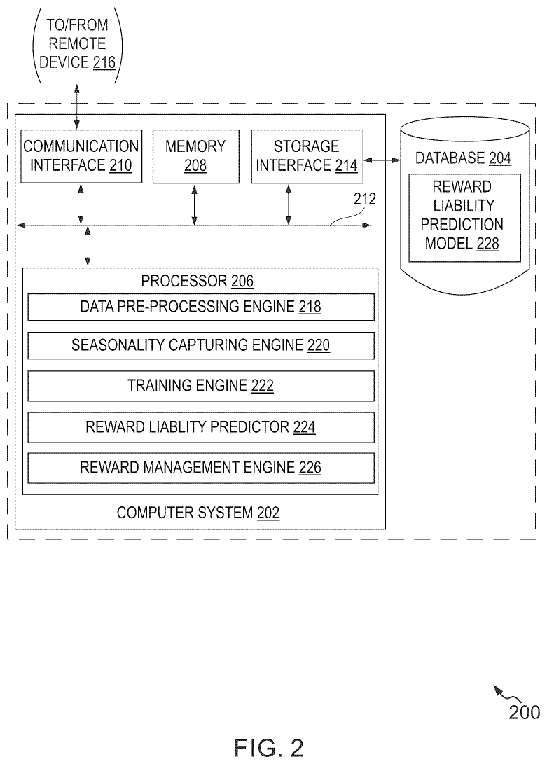

Referring now to FIG. 2, a simplified block diagram of a server system 200 is shown, in accordance with an embodiment of the present disclosure. The server system 200 is identical to the server system 102 of FIG. 1. In some embodiments, the server system 200 is embodied as a cloud-based and/or SaaS-based (software as a service) architecture.

In one embodiment, the server system 200 is configured to generate a predictive model that accurately forecasts future points liability for reward programs to release or constrain incentives to cardholders in a reward program. Particularly, the server system 200 is configured to implement a reward liability prediction model to predict future reward liability for reward program providers. The server system 200 is also configured to change reward program rules for cardholders dynamically based on the predicted future reward liability program. Additionally, the prediction will inform the reward program providers about the selection of incentives of rewards based on reward points and duration.

The server system 200 includes a computer system 202 and a database 204. The computer system 202 includes at least one processor 206 for executing instructions, a memory 208, a communication interface 210, and a storage interface 214 that communicate with each other via a bus 212.

In some embodiments, the database 204 is integrated within the computer system 202. For example, the computer system 202 may include one or more hard disk drives as the database 204. The storage interface 214 is any component capable of providing the processor 206 with access to the database 204. The storage interface 214 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing the processor 206 with access to the database 204. In one embodiment, the database 204 is configured to store model parameters of a reward liability prediction model 228.

Examples of the processor 206 include, but are not limited to, an application-specific integrated circuit (ASIC) processor, a reduced instruction set computing (RISC) processor, a complex instruction set computing (CISC) processor, a graphical processing unit (GPU), a field-programmable gate array (FPGA), and the like. The memory 208 includes suitable logic, circuitry, and/or interfaces to store a set of computer-readable instructions for performing operations. Examples of the memory 208 include a random-access memory (RAM), a read-only memory (ROM), a removable storage drive, a hard disk drive (HDD), and the like. It will be apparent to a person skilled in the art that the scope of the disclosure is not limited to realizing the memory 208 in the server system 200, as described herein. In another embodiment, the memory 208 may be realized in the form of a database server or cloud storage working in conjunction with the server system 200, without departing from the scope of the present disclosure.

The processor 206 is operatively coupled to the communication interface 210 such that the processor 206 is capable of communicating with a remote device 216 such as, the payment server 116, the issuer server 108, or communicating with any entity connected to the network 112 (as shown in FIG. 1). In one embodiment, the processor 206 is configured to access reward program data associated with the reward program provider from the reward program database 112.

It is to be noted that the server system 200 as illustrated and hereinafter described is merely illustrative of an apparatus that could benefit from embodiments of the present disclosure and, therefore, should not be taken to limit the scope of the present disclosure. It is to be noted that the server system 200 may include fewer or more components than those depicted in FIG. 2.

In one embodiment, the processor 206 includes a data pre-processing engine 218, a seasonality capturing engine 220, a training engine 222, a reward liability predictor 224, and a reward management engine 226. It should be noted that components, described herein, such as the data pre-processing engine 218, the seasonality capturing engine 220, the training engine 222, the reward liability predictor 224, and the reward management engine 226 can be configured in a variety of ways, including electronic circuitries, digital arithmetic and logic blocks, and memory systems in combination with software, firmware, and embedded technologies.

The data pre-processing engine 218 includes suitable logic and/or interfaces for accessing historical reward related data associated with one or more reward programs of a reward program provider (e.g., issuer 104a) from the reward program database 108 within a particular time interval (e.g., 3 months, 6 months, 1 year, etc.). The historical reward related data is arranged in a time-series manner. In one example, the data pre-processing engine 218 may query the reward program database 108 for retrieving information of earned and redeemed reward points of cardholders of the issuer 104a. In some implementations, the data pre-processing engine 218 executes one or more pre-processing operations on the received historical reward related data (i.e., reward redemption history). Examples of pre-processing operations performed by the data pre-processing engine 218 include normalization operations, splitting of datasets, merging of datasets, and other suitable pre-processing operations.

The historical reward related data may include, but is not limited to, reward points redeemed by cardholders of each issuer within the particular time interval, reward point value, reward expiry time, etc. For example, a bank incentivizes its cardholder's five reward points for every purchase using credit cards. The historical reward related data may include reward points redeemed by the cardholders on daily basis, weekly, or monthly basis.

In one embodiment, the data pre-processing engine 218 is configured to aggregate reward points earned by the cardholders of each issuer on a particular time basis. In general, the aggregated earned reward points are always greater than the aggregated redeemed reward points.

The seasonality capturing engine 220 includes suitable logic and/or interfaces for analyzing the historical reward related data to determine which time-series characteristics the data exhibits. The time-series characteristics may include, but are not limited to, statistical properties such as mean, standard deviation, range and skewedness. The time-series characteristics could also include seasonality, seasonal strength, number of peaks, length of time-series data, bias/level, functional trend (for example, multiplicative or addictive), outlier detection, etc. In general, identifying certain time-series characteristics may be complex and require a fair degree of analysis. For example, the seasonality can be detected by using the Fourier transform of autocorrelation. The functional trend can be detected through regression analysis methods. The seasonality capturing engine 220 may determine time-series characteristics of multiple seasonality, for instance, weekly and annual seasonality based on a seasonality identification model. In such a case, a set of forecasting models that are constrained to handle only one seasonality can be trained and tested multiple times, once for each of the determined seasonality characteristics.

Specifically, the seasonality capturing engine 220 is configured to detect seasonal components within the historical reward related data using fast-Fourier transform analysis. Thereafter, the seasonality capturing engine 220 is configured to apply seasonal decomposition methods to determine first seasonality patterns within the historical reward related data. In general, seasonal decomposition of a time-series is a statistical technique that separates time-series data into its underlying components, such as trend, seasonality, and residuals (i.e., noise component). The purpose of this decomposition is to gain insight into the underlying structure of the time series and to improve the accuracy of forecasting. The seasonal component captures the repeating patterns that occur at regular intervals (e.g. daily, weekly, or yearly patterns).

In some embodiments, the seasonal decomposition can be performed using various methods, such as classical decomposition (also known as additive or multiplicative decomposition), STL decomposition, and X-13 ARIMA-SEATS. In one example, the classical decomposition method is implemented to determine seasonality patterns. The classical decomposition method first obtains trend component with application of a convolutional filter to the time-series data (e.g., historical reward related data). Thereafter, the trend component is removed from the time-series data and the average of this de-trended time-series for each period is the returned seasonal component. In one implementation, the “frequency” parameter in the seasonal_decompose function in the statsmodels library in Python defines the number of observations in a season. This is used to determine the length of the seasonal component and to aggregate the residual component into seasons. The frequency is specified as an integer value, and it is important to choose the right frequency to ensure that the seasonal component accurately captures the repeating patterns in the data.

The first seasonality patterns represent yearly seasonality patterns. To obtain the first seasonality patterns, the seasonality capturing engine 220 is configured to set the frequency value as 365.

The seasonality capturing engine 220 is configured to capture second seasonality patterns intrinsically by seasonal auto-regressive integrated moving average (SARIMA) time-series model using seasonal lags in moving average and auto-regressive components. This is done by including seasonal differences in the model, which involves taking the difference between the current value of the time series and the value from the same week in the previous year. The seasonal lags in the moving average and autoregressive components capture the residual seasonality that may still exist in the time series data after seasonal differences have been taken. By incorporating seasonal lags into the model, the SARIMA time-series model can capture the intrinsic seasonality in the data without the need for external features or exogenous variables. For example, if the time series data exhibits weekly seasonality, then the SARIMA time-series model will include lagged values of the time series at the same day of the week in previous weeks, as well as lagged errors from the same day of the week in previous weeks, to capture the weekly patterns.

The training engine 222 includes suitable logic and/or interfaces for training a reward liability prediction model based, at least in part, on first and second seasonality patterns. In one embodiment, the reward liability prediction model is implemented based at least one of a plurality of time-series forecasting models. The plurality of time-series forecasting models may include, but is not limited to, Autoregressive Moving Average (ARMA) model, seasonal auto-regressive integrated moving average (SARIMA) time-series model, Exponential smoothing (EM) model, nonlinear Regression Models, non-regression based models, and non-parametric regression based models, etc.

The training engine 222 is configured to train the reward liability prediction model with multiple seasonality data and exogenous variables. In general, the exogenous variables, also known as external variables or covariates, can be included as additional predictors in the SARIMA model. These variables are not part of the time-series itself, but have an impact on the response variable and can help to improve the accuracy of the forecast.

In one embodiment, the exogenous variables include at least: 1) correlated variable i.e., aggregated earned reward points, 2) at least one seasonality pattern, 3) yearly trend patterns, etc. In one example, the exogenous variables may also include other variables such as reward redemption effect due to holidays (since there are always greater chances of getting rewards redeemed in general circumstances). The SARIMA model with exogenous variables can be used to capture the relationships between the response variable and the exogenous variables, as well as the seasonal and non-seasonal patterns in the time-series data. The exogenous variables include at least one seasonality pattern and a correlated variable. In one embodiment, the at least one seasonality pattern is determined based on a frequency level. The seasonality patterns that have lesser frequency level are selected as one of the exogenous variables. In this implementation, the first seasonality patterns (i.e., yearly seasonality) are considered as one of the exogenous variables.

The training engine 222 is configured to input second or weekly seasonality patterns as the seasonality variable and the first seasonality patterns and aggregated earned reward points as the exogenous variables. The weekly seasonality is captured intrinsically by the SARIMA algorithm using seasonal lags in the moving average and auto-regressive components.

During the training, model parameters such as, order of the auto-regressive (AR) and moving average (MA) components, the order of the seasonal components, and the lag order of the exogenous variables are initialized in accordance with input data. In addition, the training engine 222 may need to perform model selection and parameter tuning to select the best SARIMA model for the historical reward related data. This process may involve trying different combinations of AR and MA parameters, seasonal parameters, and exogenous variable lags to find the model that gives the best forecast accuracy.

In one embodiment, the training engine 222 is configured to implement grid-search and Akaike Information Criterion (AIC) in determining predictive capability of the reward liability prediction model, thereby optimizing the hyper-parameters like the order of auto-regressive (AR) and moving average (MA) components.

The training engine 222 is also configured to test the forecasting accuracy of the trained reward liability prediction model by comparing estimated or forecasted time-series values with observed or sampled values. To evaluate the performance of the reward liability prediction model, evaluation metrics such as mean absolute percentage error (MAPE) is calculated. The reward liability prediction model is considered to be trained when its model parameters have been estimated based on the historical reward related data. The model parameters are used to capture the relationships between the past values of the time-series and the current value of the time-series, as well as the seasonal patterns in the historical reward related data. For selecting different model parameters, the stationarity of input data is analyzed with respect to the generated output of the reward liability prediction model 228.

Once the reward liability prediction model is trained, the reward liability prediction model is configured to predict future reward points to be redeemed in the reward program.

The reward liability predictor 224 includes suitable logic and/or interfaces for predicting the fund liability of the reward program in the future based, at least in part, on the predicted future reward points to be redeemed in the reward program predicted by the reward liability prediction model.

The reward management engine 226 includes suitable logic and/or interfaces for modifying the reward program based on the predicted fund liability for running the reward program. The reward management engine 226 may release or constrain incentives applied to consumers in the rewards program at a program, segment, or individual level.

In particular, the reward management engine 226 takes one or more data inputs to modify the variables of the reward program. The one or more data inputs may include reward liability forecasting data (i.e., output of the reward liability predictor 224) denoted as ‘DI1’, reward promotions/spend impact rules (denoted as ‘DI2’), and consumer segmentation data map (denoted as ‘DI3’). The consumer segmentation data map helps in identifying groups of cardholders with similar spending behavior and providing targeting promotions to the groups of cardholders. The consumer segmentation can be applied to the entire reward consumer population at scale.

Additionally, the reward management engine 226 may also take manual input such as reward liability thresholds (budgetₘₐₓ and budgetₘᵢₙ) from reward program managers.

The reward management engine 226 compares ‘DI1’ with the reward liability thresholds. Based on the comparison, the reward management engine 226 may restrict, maintain or accelerate reward points earning/utilization. The reward management engine 226 also ranks promotions/rules from high to low spend impact and determines a list of reward rules (with poor/lower/small spend impact) to be disabled. In one scenario, if the ‘DI1’ is greater than budgetₘₐₓ, the reward management engine 226 removes more reward rules in addition to the list of reward rules. In another scenario, if the ‘DI1’ is in range of the reward liability thresholds, the reward management engine 226 may maintain the reward points earning/utilization and while the list of reward rules is kept enabled. In yet another scenario, if the ‘DI1’ is less than the budgetₘᵢₙ, the reward management engine 226 enables more reward rules while keeping the list of reward rules enabled.

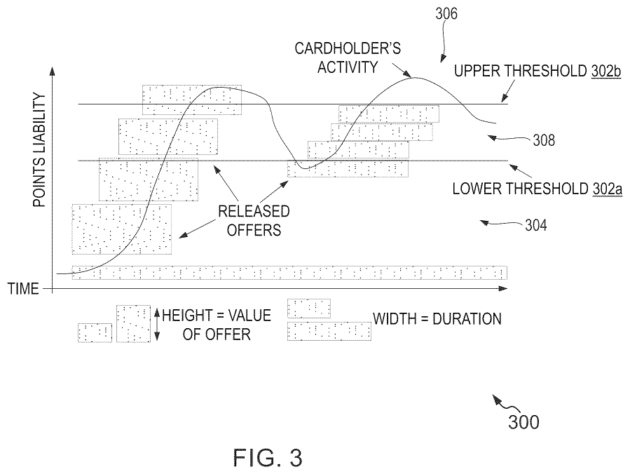

FIG. 3 is a plot 300 representing the effects of controlling reward point liability based on reward liability prediction model, in accordance with an embodiment of the present disclosure.

As mentioned earlier, the reward liability prediction model 228 is configured to predict future reward points liability for a reward program. Based on the prediction of the future reward points liability, the server system 200 modifies the reward program to manage fund liability. In another embodiment, the server system 200 recommends one or more controlling measures or actions that can be taken to improve fund allocation in reward programs.

In one embodiment, the server system 200 is configured to update incentives and duration of reward programs based on the prediction output of the reward liability prediction model 228. The server system 200 is configured to assess reward points liabilities of the reward program for a duration and measure the magnitude of variance against lower reward budget threshold 302a and upper reward budget threshold 302b. Based on the magnitude of the variance, the server system 200 is configured to determine where reward liability is projected to fail. The plot 300 can be divided into three different regions 304, 306, and 308.

For a time period of the first region 304, the server system 200 determines that the number of redeemed reward points is below a threshold range. In such case, the server system 200 modifies or adapts the reward program to drive reward program usage by releasing offers with high incentive value and longer duration.

For a time period of the second region 306, the server system 200 determines that the number of redeemed reward points is beyond the threshold range. In such cases, the server system 200 proactively manages the reward program to curtail loyalty usage by withholding higher incentives and longer duration offers.

For a time period of the third region 308, the server system 200 determines that the server system 200 determines that the number of redeemed reward points is within the threshold range. In such case, the server system 200 proactively adapts the reward program to release offers with lower incentives and shorter duration.

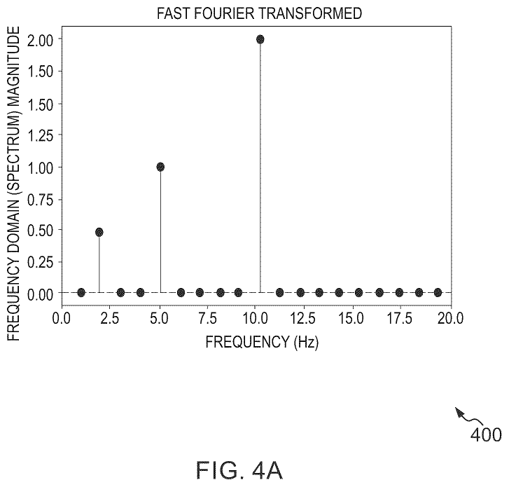

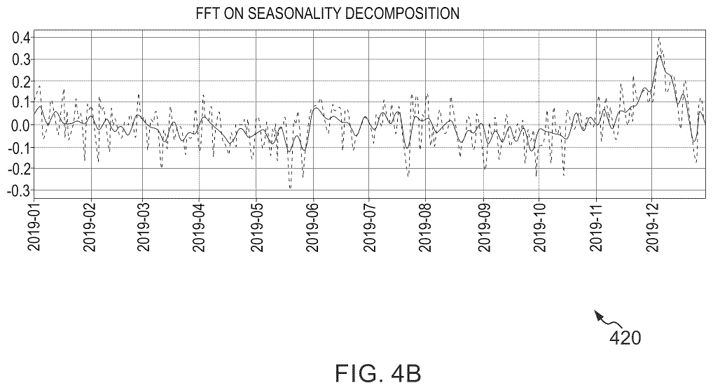

FIGS. 4A and 4B represent plots 400 and 420 of seasonality detection within the historical reward related data of reward programs, in accordance with an embodiment of the present disclosure. As shown, the server system 200 is configured to detect seasonal components within the historical reward related data using fast-Fourier transform analysis (see, 400). Thereafter, the seasonality capturing engine 220 is configured to apply seasonal decomposition methods to determine first seasonality patterns within the historical reward-related data (see, 420).

In general, seasonal decomposition of a time-series is a statistical technique that separates time-series data into its underlying components, such as trend, seasonality, and residuals (i.e., noise component). The purpose of this decomposition is to gain insight into the underlying structure of the time-series data and to improve the accuracy of forecasting. The seasonal component captures the repeating patterns that occur at regular intervals (e.g. daily, weekly, or yearly patterns).

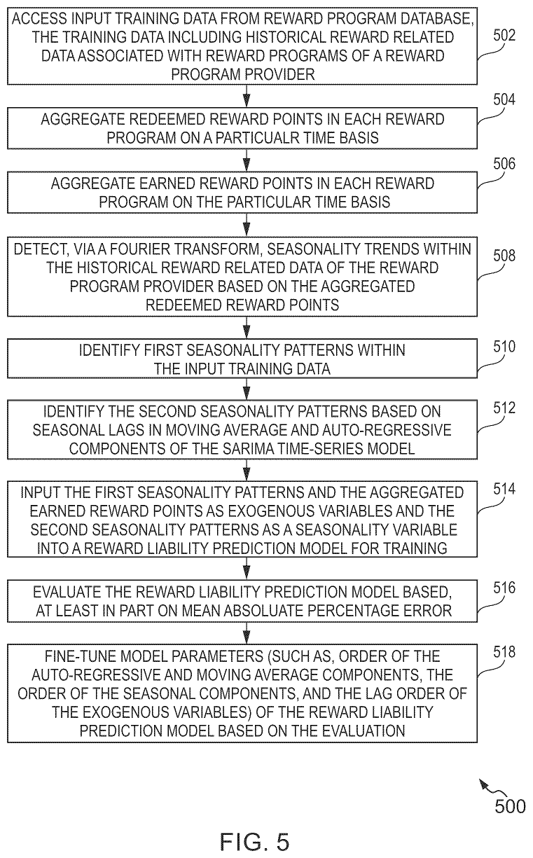

FIG. 5 is a process flow chart of a method 500 for training a reward liability prediction model, in accordance with an embodiment of the present disclosure. The sequence of operations of the method 500 may not be necessarily executed in the same order as they are presented. Further, one or more operations may be grouped and performed in the form of a single step, or one operation may have several sub-steps that may be performed in parallel or in a sequential manner. Operations of the method 500, and combinations of operation in the method may be implemented by, for example, hardware, firmware, a processor, circuitry, and/or a different device associated with the execution of software that includes one or more computer program instructions. The process flow starts at operation 502.

At 502, the server system 200 accesses historical reward related data associated with a reward program of the reward program provider 116 (for example, issuer 104a). The historical reward related data may include time-series data of redeemed reward points in the reward program on a daily basis. Specifically, the server system 200 utilizes daily-level redeemed reward points in the reward program as input training data. In one embodiment, the historical reward related data may also include time-series data of earned reward points in the reward program on the daily basis.

At 504, the server system 200 aggregates redeemed reward points for the reward program on a particular time basis (i.e., daily basis) and generates time-series data. In other words, the server system 200 aggregates total reward points redeemed day-wise irrespective of when these reward points are earned.

At 506, the server system 200 aggregates earned reward points for the reward program on the particular time basis. It should be noted that redeemed reward points are highly correlated with earned reward points.

At 508, the server system 200 detects seasonality trends or patterns within the input training data based, at least in part, on the aggregated redeemed reward points using fast Fourier transform analysis.

At 510, the server system 200 identifies first seasonality patterns within the input training data. The first seasonality patterns is captured by a seasonality decomposition model implementing classical decomposition method. The classical decomposition method first obtains trend component with application of a convolutional filter to the time-series data (e.g., historical reward related data). Thereafter, the trend component is removed from the time-series data and the average of this de-trended time-series for each period is the returned seasonal component. The first seasonality patterns represents yearly seasonal time-series data.

At 512, the server system 200 identifies the second seasonality patterns within the input training data based on seasonal lags in moving average and auto-regressive components of the SARIMA time-series model. For current implementation, the second seasonality patterns represent weekly time-series data. However, in some other implementations, the second seasonality patterns may represent daily time-series data and the first seasonality patterns may represent weekly time-series data or monthly time-series data. Thus, there are multiple combinations of first and second seasonality patterns possible for a different type of input data.

Consequently, the second seasonality patterns is captured intrinsically by the SARIMA model using seasonal lags in the moving average and auto-regressive components, whereas the first seasonality patterns are generated separately using the classical or STL decomposition and fed to the SARIMA model as an external feature.

At 514, the server system 200 inputs the first seasonality patterns and the aggregated earned reward points as exogenous variables and the second seasonality patterns as a seasonality variable into the reward liability prediction model 228 for training. In one embodiment, the reward liability prediction model is a seasonal auto-regressive integrated moving average (SARIMA) time-series model with multiple seasonality. The multiple seasonality can also be incorporated into a single SARIMA model by using the SARIMA model with multiple seasonal differencing and seasonal auto-regression terms. Further, the exogenous variables, also known as external variables or covariates, improve the accuracy of the forecast.

It should be noted that the weekly seasonality as the seasonality variable input in the reward liability prediction model provides better training results rather than yearly seasonality.

At 516, the server system 200 computes the mean absolute percentage error (MAPE) and evaluates performance of the reward liability prediction model based on the MAPE. At 518, the server system 200 fine-tunes model parameters (such as, order of the auto-regressive and moving average components, the order of the seasonal components, and the lag order of the exogenous variables) of the reward liability prediction model. It is to be noted that the objective of the fine-tuning is to minimize the MAPE as much as possible. For example, the MAPE value may be minimized until it is less than a threshold value. Thereafter, the server system 200 performs post-processing to calculate the fund liability of the reward program based on the determination of future reward points to be redeemed.

The sequence of steps of the method 500 need not be necessarily executed in the same order as they are presented. Further, one or more operations may be grouped together and performed in form of a single step, or one operation may have several sub-steps that may be performed in parallel or in a sequential manner.

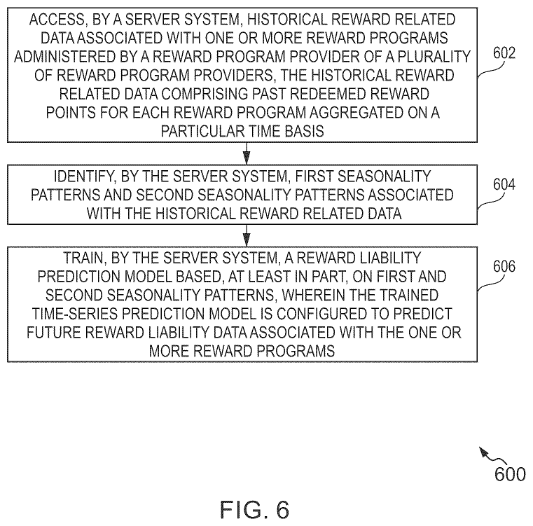

FIG. 6 is a process flow chart of a computer-implemented method 600 for training a reward liability prediction model to determine future reward liability in a reward program, in accordance with an embodiment of the present disclosure. The method 600 depicted in the flow chart may be executed by, for example, a computer system. The computer system is identical to the server system 200. Operations of the flow chart of the method 600, and combinations of operations in the flow chart of the method 600, may be implemented by, for example, hardware, firmware, a processor, circuitry, and/or a different device associated with the execution of software that includes one or more computer program instructions. It is noted that the operations of the method 600 can be described and/or practiced by using a system other than these computer systems. The method 600 starts at operation 602.

At operation 602, the method 600 includes accessing, by the server system 200, historical reward related data associated with one or more reward programs administered by a reward program provider of a plurality of reward program providers. The historical reward related data includes at least past redeemed reward points for each reward program aggregated on a particular time basis.

At operation 604, the method 600 includes identifying, by the server system 200, first seasonality patterns and second seasonality patterns associated with the historical reward related data.

At operation 606, the method 600 includes training, by the server system 200, a reward liability prediction model based, at least in part, on first and second seasonality patterns. The reward liability prediction model is configured to predict future reward liability data associated with the one or more reward programs.

The sequence of operations of the method 600 need not be necessarily executed in the same order as they are presented. Further, one or more operations may be grouped together and performed in form of a single step, or one operation may have several sub-steps that may be performed in parallel or in a sequential manner.

### Performance Metrics

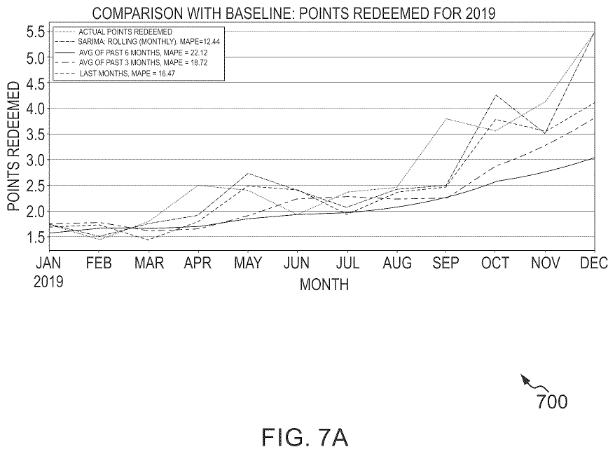

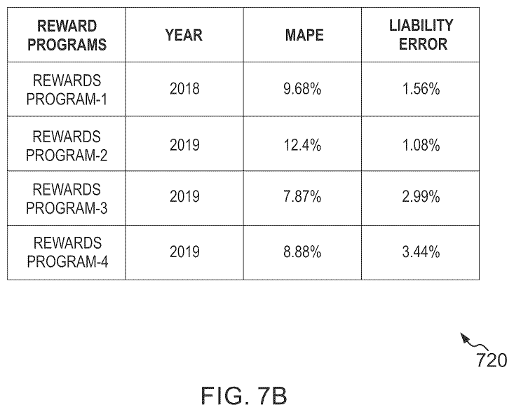

FIG. 7A is a graphical representation 700 comparing the prediction efficiency of the baseline prediction model with the proposed reward liability prediction model 228. The graphical representation 700 depicts a comparison of predicted outputs of the baseline prediction model for different durations (e.g., last month, last 3 months, and last 6 months) with a prediction output of the reward liability prediction model 228. It can be seen that the prediction output of the reward liability prediction model (see, orange graph line, SARIMA Rolling (monthly)) has lesser MAPE among other prediction outputs of the baseline prediction model.

FIG. 7B is a tabular representation 720 of reward liability prediction of reward programs for different reward programs, in accordance with an embodiment of the present disclosure. An experiment is performed to evaluate the performance metrics of the reward liability prediction model 228. In addition, reward point datasets for different reward programs are used as input data. The reward liability prediction model 228 is trained using historical reward time-series data of the last two years. The tabular representation shows error in prediction when compared with actual reward liability data. For an exemplary prototype reward program, the proposed method predicts the reward liability with just 1% error (for year 2019), whereas the baseline model underestimated the reward liability by around 35%.

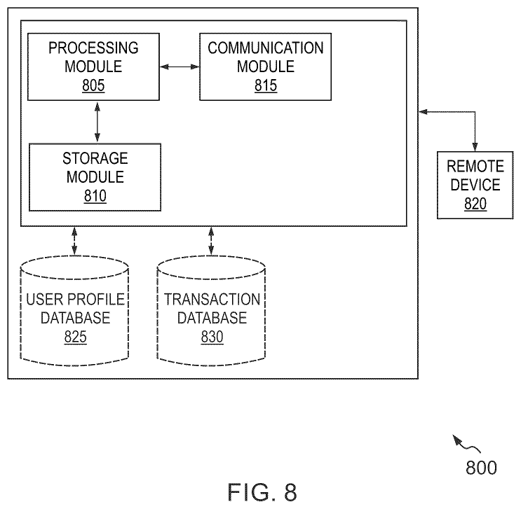

FIG. 8 illustrates a simplified block diagram of an issuer server 800, in accordance with an embodiment of the present disclosure. The issuer server 800 is an example of the issuer server 104a of FIG. 1. The issuer server 800 is associated with an acquirer bank/acquirer, in which a merchant may have an account, which provides a payment card. The issuer server 800 includes a processing module 805 operatively coupled to a storage module 810 and a communication module 815. The components of the issuer server 800 provided herein may not be exhaustive and the issuer server 800 may include more or fewer components than those depicted in FIG. 8. Further, two or more components may be embodied in one single component, and/or one component may be configured using multiple sub-components to achieve the desired functionalities. Some components of the issuer server 800 may be configured using hardware elements, software elements, firmware elements and/or a combination thereof.

The storage module 810 is configured to store machine-executable instructions to be accessed by the processing module 805. Additionally, the storage module 810 stores information related to, contact information of the merchant, bank account number, availability of funds in the account, payment card details, transaction details, and/or the like. Further, the storage module 810 is configured to store payment transactions.

In one embodiment, the issuer server 800 is configured to store profile data (e.g., an account balance, a credit line, details of the cardholders 106, account identification information, and payment card number). The details of the cardholders 104 may include, but are not limited to, name, age, gender, physical attributes, location, registered contact number, family information, alternate contact number, registered e-mail address, etc.

The processing module 805 is configured to communicate with one or more remote devices such as a remote device 820 using the communication module 815 over a network such as the network 114 of FIG. 1. The examples of the remote device 820 include the server system 102, the payment server 110, the reward program database 112, or other computing systems of the issuer server 800 and the like. The communication module 815 is capable of facilitating such operative communication with the remote devices and cloud servers using API (Application Program Interface) calls. The communication module 815 is configured to receive a payment transaction request performed by the cardholders 106 via the network 114. The processing module 805 receives a payment card information, a payment transaction amount, a customer information, and merchant information from the remote device 820 (i.e., the payment server 110). The issuer server 800 includes a user profile database 825 and a transaction database 830 for storing transaction data and earned reward points history. The user profile database 825 may include information of cardholders. The transaction data may include, but is not limited to, transaction attributes, such as transaction amount, source of funds such as bank or credit cards, transaction channel used for loading funds such as POS terminal or ATM machine, transaction velocity features such as count and transaction amount sent in the past x days to a particular user, transaction location information, external data sources, and other internal data to evaluate each transaction.

The disclosed methods with reference to FIGS. 1 to 8, or one or more operations of the methods 500 and 600 may be implemented using software including computer-executable instructions stored on one or more computer-readable media (e.g., non-transitory computer-readable media, such as one or more optical media discs, volatile memory components (e.g., DRAM or SRAM), or nonvolatile memory or storage components (e.g., hard drives or solid-state nonvolatile memory components, such as Flash memory components) and executed on a computer (e.g., any suitable computer, such as a laptop computer, netbook, Web book, tablet computing device, smartphone, or other mobile computing devices). Such software may be executed, for example, on a single local computer or in a network environment (e.g., via the Internet, a wide-area network, a local-area network, a remote web-based server, a client-server network (such as a cloud computing network), or other such networks) using one or more network computers. Additionally, any of the intermediate or final data created and used during the implementation of the disclosed methods or systems may also be stored on one or more computer-readable media (e.g., non-transitory computer-readable media) and are considered to be within the scope of the disclosed technology. Furthermore, any of the software-based embodiments may be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

Although the disclosure has been described with reference to specific exemplary embodiments, it is noted that various modifications and changes may be made to these embodiments without departing from the broad spirit and scope of the disclosure. For example, the various operations, blocks, etc. described herein may be enabled and operated using hardware circuitry (for example, complementary metal oxide semiconductor (CMOS) based logic circuitry), firmware, software and/or any combination of hardware, firmware, and/or software (for example, embodied in a machine-readable medium). For example, the apparatuses and methods may be embodied using transistors, logic gates, and electrical circuits (for example, application-specific integrated circuit (ASIC) circuitry and/or in Digital Signal Processor (DSP) circuitry).

Particularly, the server system 200 (e.g., the server system 102) and its various components such as the computer system 202 and the database 204 may be enabled using software and/or using transistors, logic gates, and electrical circuits (for example, integrated circuit circuitry such as ASIC circuitry). Various embodiments of the disclosure may include one or more computer programs stored or otherwise embodied on a computer-readable medium, wherein the computer programs are configured to cause a processor or computer to perform one or more operations. A computer-readable medium storing, embodying, or encoded with a computer program, or similar language, may be embodied as a tangible data storage device storing one or more software programs that are configured to cause a processor or computer to perform one or more operations. Such operations may be, for example, any of the steps or operations described herein. In some embodiments, the computer programs may be stored and provided to a computer using any type of non-transitory computer-readable media. Non-transitory computer-readable media include any type of tangible storage media. Examples of non-transitory computer-readable media include magnetic storage media (such as floppy disks, magnetic tapes, hard disk drives, etc.), optical magnetic storage media (e.g., magneto-optical disks), CD-ROM (compact disc read only memory), CD-R (compact disc recordable), CD-R/W (compact disc rewritable), DVD (Digital Versatile Disc), BD (BLU-RAY® Disc), and semiconductor memories (such as mask ROM, PROM (programmable ROM), EPROM (erasable PROM), flash memory, RAM (random access memory), etc.). Additionally, a tangible data storage device may be embodied as one or more volatile memory devices, one or more non-volatile memory devices, and/or a combination of one or more volatile memory devices and non-volatile memory devices. In some embodiments, the computer programs may be provided to a computer using any type of transitory computer readable media. Examples of transitory computer readable media include electric signals, optical signals, and electromagnetic waves. Transitory computer readable media can provide the program to a computer via a wired communication line (e.g., electric wires, and optical fibers) or a wireless communication line.

Various embodiments of the invention, as discussed above, may be practiced with steps and/or operations in a different order, and/or with hardware elements in configurations, which are different than those which are disclosed. Therefore, although the invention has been described based upon these exemplary embodiments, it is noted that certain modifications, variations, and alternative constructions may be apparent and well within the spirit and scope of the invention.

Although various exemplary embodiments of the invention are described herein in a language specific to structural features and/or methodological acts, the subject matter defined in the appended claims is not necessarily limited to the specific features or acts described above. Rather, the specific features and acts described above are disclosed as exemplary forms of implementing the claims.

With that said, and as described, it should be appreciated that one or more aspects of the present disclosure transform a general-purpose computing device into a special-purpose computing device (or computer) when configured to perform the functions, methods, and/or processes described herein. In connection therewith, in various embodiments, computer-executable instructions (or code) may be stored in memory of such computing device for execution by a processor to cause the processor to perform one or more of the functions, methods, and/or processes described herein, such that the memory is a physical, tangible, and non-transitory computer readable storage media. Such instructions often improve the efficiencies and/or performance of the processor that is performing one or more of the various operations herein. It should be appreciated that the memory may include a variety of different memories, each implemented in one or more of the operations or processes described herein. What's more, a computing device as used herein may include a single computing device or multiple computing devices.

In addition, and as described, the terminology used herein is for the purpose of describing particular exemplary embodiments only and is not intended to be limiting. As used herein, the singular forms “a,” “an,” and “the” may be intended to include the plural forms as well, unless the context clearly indicates otherwise. And, again, the terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “included with,” or “in communication with” another feature, it may be directly on, engaged, connected, coupled, associated, included, or in communication to or with the other feature, or intervening features may be present. As used herein, the term “and/or” and the term “at least one of” includes any and all combinations of one or more of the associated listed items.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

It is also noted that none of the elements recited in the claims herein are intended to be a means-plus-function element within the meaning of 35 U.S.C. § 112(f) unless an element is expressly recited using the phrase “means for,” or in the case of a method claim using the phrases “operation for” or “step for.”

Again, the foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method, comprising:
accessing, by a server system, historical reward related data associated with one or more reward programs administered by a reward program provider of a plurality of reward program providers, the historical reward related data comprising past redeemed reward points for each reward program aggregated on a particular time basis;
identifying, by the server system, first seasonality patterns and second seasonality patterns associated with the historical reward related data; and
training, by the server system, a reward liability prediction model based, at least in part, on first and second seasonality patterns, wherein the trained time-series prediction model is configured to predict future reward liability data associated with the one or more reward programs.

2. The computer-implemented method as claimed in claim 1, wherein the reward liability prediction model is implemented based at least on a seasonal auto-regressive integrated moving average (SARIMA) time-series model.

3. The computer-implemented method as claimed in claim 2, wherein identifying the first seasonality patterns and the second seasonality patterns comprises:
detecting, by the server system, seasonality trends within the historical reward related data of each reward program provider based, at least in part, on fast-Fourier transform (FFT) method;
upon determination of the seasonality trends, identifying, by the server system, the first seasonality patterns within the historical reward related data based, at least in part, on a seasonality decomposition model; and
determining, by the server system, the second seasonality patterns based, at least in part, on seasonal lags in moving average and auto-regressive components of the SARIMA time-series model.

4. The computer-implemented method as claimed in claim 1, wherein the first seasonality patterns comprise a yearly seasonal component of the past redeemed reward points and the second seasonality patterns comprise a weekly seasonal component of the past redeemed reward points.

5. The computer-implemented method as claimed in claim 1, wherein the reward liability prediction model is further trained based, at least in part, on exogenous variables, the exogenous variables comprising at least one seasonality pattern and a correlated variable.

6. The computer-implemented method as claimed in claim 5, wherein the correlated variable comprises aggregated earned reward points in each reward program for the reward program provider.

7. The computer-implemented method as claimed in claim 1, wherein the past redeemed reward points for each reward program are aggregated on daily time basis.

8. The computer-implemented method as claimed in claim 1, wherein, upon training the reward liability prediction model, the computer-implemented method further comprises:
predicting, by the server system, the future reward liability data associated with the one or more reward programs; and
modifying, by the server system, reward rules associated with the one or more reward programs based, at least in part, the predicted future reward liability data and one or more reward liability criteria.

9. The computer-implemented method as claimed in claim 1, wherein the reward program provider is an issuer.

10. A server system comprising at least one computing device configured to:
access historical reward related data associated with one or more reward programs administered by a reward program provider of a plurality of reward program providers, the historical reward related data comprising past redeemed reward points for each reward program aggregated on a particular time basis;
identify first seasonality patterns and second seasonality patterns associated with the historical reward related data; and
train a reward liability prediction model based, at least in part, on first and second seasonality patterns, wherein the trained time-series prediction model is configured to predict future reward liability data associated with the one or more reward programs.

11. The server system as claimed in claim 10, wherein the reward liability prediction model is implemented based at least on a seasonal auto-regressive integrated moving average (SARIMA) time-series model.

12. The server system as claimed in claim 11, wherein the at least one computing device is configured, in order to identify the first seasonality patterns and the second seasonality patterns, to:
detect seasonality trends within the historical reward related data of each reward program provider based, at least in part, on fast-Fourier transform (FFT) method;
upon determination of the seasonality trends, identify the first seasonality patterns within the historical reward related data based, at least in part, on a seasonality decomposition model; and
determine the second seasonality patterns based, at least in part, on seasonal lags in moving average and auto-regressive components of the SARIMA time-series model.

13. The server system as claimed in claim 10, wherein the first seasonality patterns comprise a yearly seasonal component of the past redeemed reward points and the second seasonality patterns comprise a weekly seasonal component of the past redeemed reward points.

14. The server system as claimed in claim 10, wherein the reward liability prediction model is further trained based, at least in part, on exogenous variables, the exogenous variables comprising at least one seasonality pattern and a correlated variable; and
wherein the correlated variable comprises aggregated earned reward points in each reward program for the reward program provider.

15. The server system as claimed in claim 10, wherein the past redeemed reward points for each reward program are aggregated on daily time basis.

16. The server system as claimed in claim 10, wherein, upon training the reward liability prediction model, the at least one computing device is further configured to:
predict the future reward liability data associated with the one or more reward programs; and
modify reward rules associated with the one or more reward programs based, at least in part, the predicted future reward liability data and one or more reward liability criteria.

17. The server system as claimed in claim 10, wherein the reward program provider is an issuer.

18. A non-transitory computer-readable storage medium comprising executable instructions, which when executed by at least one processor of a server system, cause the at least one processor to:
access historical reward related data associated with one or more reward programs administered by a reward program provider of a plurality of reward program providers, the historical reward related data comprising past redeemed reward points for each reward program aggregated on a particular time basis;
identify first seasonality patterns and second seasonality patterns associated with the historical reward related data; and
train a reward liability prediction model based, at least in part, on first and second seasonality patterns, wherein the trained time-series prediction model is configured to predict future reward liability data associated with the one or more reward programs.
